(19) United States
(12) Patent Application Publication
(10) Pub. No.: US 2026/0231220 A1
(43) Pub. Date: Aug. 6, 2026

(54) EARLY CSI REPORTING WHEN TRANSITIONING TO RRC-CONNECTED STATE

(71) Applicant: InterDigital Patent Holdings, Inc., Wilmington, DE (US)

(72) Inventors: Jonghyun Park, Syosset, NY (US); Afshin Haghighat, Ile-Bizard (CA); Moon IL Lee, Melville, NY (US); Loic Canonne-Velasquez, Dorval (CA); Virgil Comsa, Montreal (CA); Dylan Watts, Montreal (CA); Mohammad Irfan, Chateauguay (CA)

(73) Assignee: InterDigital Patent Holdings, Inc., Wilmington, DE (US)

(21) Appl. No.: 19/043,918

(22) Filed: Feb. 3, 2025

(51) Int. Cl. H04W 74/0833; H04B 7/06; H04W 74/08

(52) U.S. Cl. CPC H04W 74/0833; H04B 7/0626; H04B 7/06968; H04W 74/0891

(57) ABSTRACT

A wireless transmit/receive unit (WTRU) may be configured to perform early channel state information (CSI) measurement and/or reporting. Early CSI measurement and/or reporting may differ from traditional CSI measurement and/or reporting in that early CSI measurement/reporting may be performed in association with a two or four step random access channel (RACH) procedure. For example, the WTRU may receive a synchronization signal block (SSB). The WTRU may send a first RACH message based on the SSB. The WTRU may receive a random access response (RAR). The RAR may indicate a resource for early CSI measurement. The WTRU may perform measurement of the early CSI resource and send a report. The report may be sent as part of the random access procedure, for example, in a RACH msg3.

### BACKGROUND

Existing cellular networks support channel state information (CSI) and/or beam reporting procedures, along with beam switch and update mechanisms, when a WTRU is in the radio resource control (RRC)-connected state. After successful attachment to a serving cell via initial access procedures such as random access channel (RACH) procedures, the WTRU reports its capabilities regarding CSI and beam measurement and reporting. Then, the network provides extensive WTRU-dedicated RRC configuration signaling that specifies the procedures for the CSI and/or beam reporting, including the configuration of DL RS (e.g., CSI-RS) and the associated measurement parameters.

When transitioning from an RRC-idle state to an RRC-connected state (e.g., via the 4-step or 2-step RACH procedure) significant latency can occur before the WTRU is able to perform stable and accurate CSI-RS measurements and CSI/beam reporting. This delay arises because the WTRU must receive and process substantial amounts of dedicated RRC configuration signaling, measure the configured downlink (DL) reference signals (RSs), derive CSI or beam measurement results (e.g., rank indicator (RI), precoding matrix indicator (PMI), channel quality indicator (CQI), layer 1 (L1)-reference signal received power (RSRP), L1-signal to interference plus noise ratio (SINR)), and finally send the CSI/beam report to the base station (BS) by using the allocated uplink (UL) reporting resource. The BS can use this reported information to optimize data scheduling grant. Since the WTRU may frequently fall into the RRC-idle state, for example, due to data buffer inactivity and for power-saving purpose, the repeated configuration due to the released RRC parameters whenever entering the RRC-idle state, measurement, and reporting cycles may introduce significant latency.

### SUMMARY

A wireless transmit/receive unit (WTRU) may be configured to perform early channel state information (CSI) reporting when transitioning from radio resource control (RRC)-idle/inactive to RRC-connected state. The WTRU may be configured to perform paging procedures and early CSI reporting. The WTRU may derive early CSI measurements based on a default reference signal (RS). Early CSI reporting may be associated with a random-access procedure. The WTRU may be configured to perform certain early CSI reporting behaviors while in an inactive/dormant state. Early CSI reporting behavior may be associated with a 2-step random access channel (RACH) procedure.

The embodiments described herein may help to reduce CSI/beam reporting latency in a scenario when a WTRU enters the RRC-connected state from the RRC idle/inactive state, during WTRU/NW dormancy, and even during initial access procedures.

A WTRU may include a processor. The WTRU may receive system information (SI). The SI may comprise a synchronization signal block (SSB). The WTRU may transmit a first physical random access channel (PRACH) message based on the SSB. The WTRU may receive a random access response (RAR). The RAR may comprise a field that indicates the WTRU should perform early CSI reporting. For example, the RAR may comprise a field that indicates a time or event after which the WTRU is to perform early CSI reporting.

The RAR may comprise one or more parameters for early CSI reporting, wherein the parameters for early CSI reporting indicate a resource for early CSI measurement. The WTRU may determine a quasi-co-location (QCL) association between the resource for early CSI measurement and the SSB. For example, the WTRU may determine a QCL type C (e.g., doppler shift or average delay) or QCL type D (e.g., spatial Rx) relationship between the resource for CSI measurement and the SSB. The WTRU may determine a CSI measurement of the resource for early CSI measurement. The WTRU may send an early CSI report indicating the CSI measurement. In examples, the early CSI report may be sent in a random access procedure message, for example, a random access Msg3.

The resource for early CSI measurement may comprise a tracking reference signal (TRS). The processor may be configured to determine the measurement of the resource for early CSI measurement by measuring the TRS. Additionally, or alternatively, the resource for early CSI measurement may comprise a demodulation reference signal (DMRS) associated with the SSB. The processor may be configured to determine the measurement of the resource for early CSI measurement by measuring the SSB and the DMRS.

The WTRU may determine a layer 1 (L1) reference signal received power (RSRP) and/or an L1 signal to interference plus noise ratio (SINR) when determining the CSI measurement. Additionally, or alternatively, the CSI measurement may indicate a rank indicator (RI), a precoding matrix indicator (PMI), and/or a channel quality indicator (CQI).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a block diagram illustrating an example of a downlink control information (DCI) field of a DCI for unified transmission configuration indicator (TCI)-state indications.

FIG. 3 is a flow chart illustrating an example of a paging procedure for early channel state information (CSI) measurement and reporting.

### DETAILED DESCRIPTION

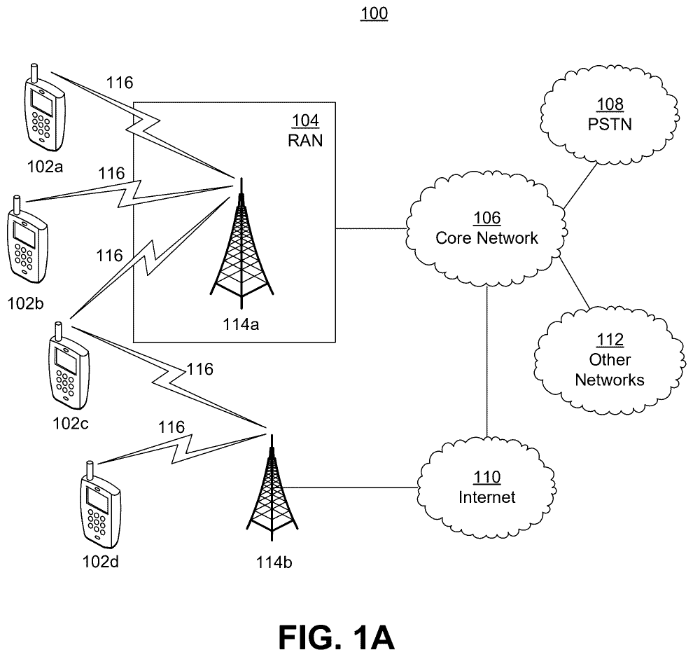

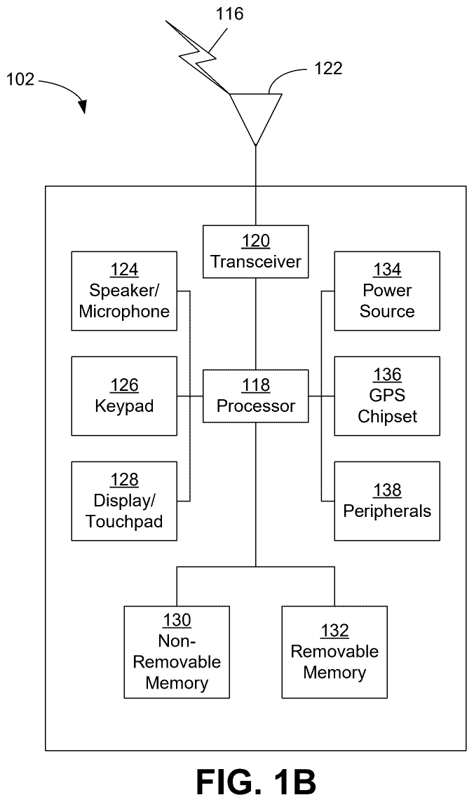

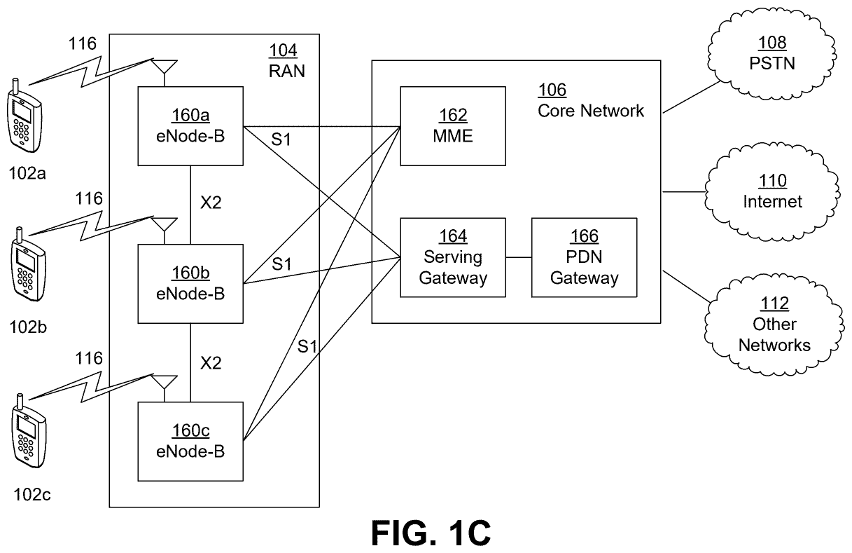

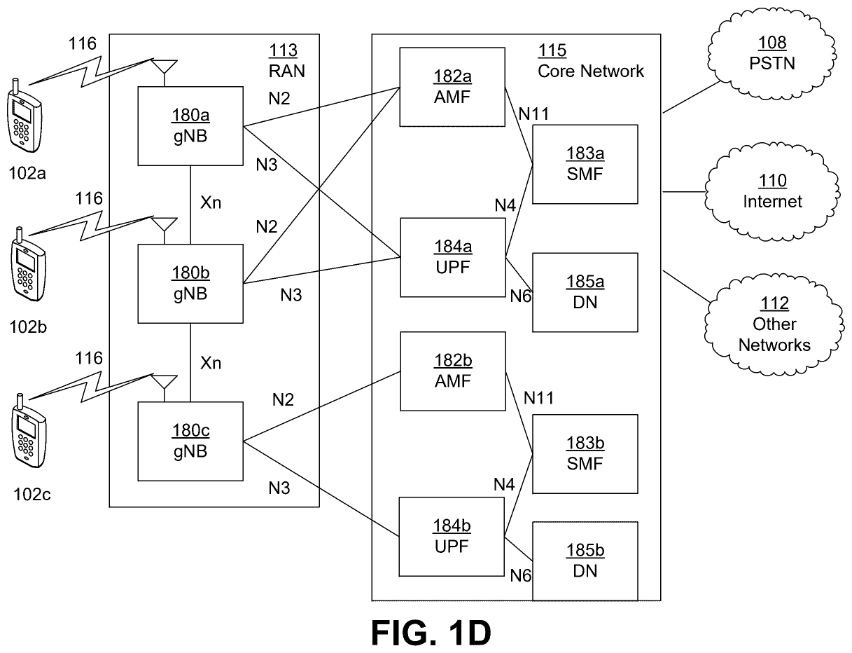

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, the terms prediction and estimation may be used interchangeably. Herein, the terms candidate cell, neighbor cell, and target cell may be used interchangeably. Herein, the terms source cell, current cell, and serving cell may be used interchangeably.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS), such as CSI-RS, or a synchronization signal (SS) block. The WTRU transmission may be referred to as a “target”, and the received RS or SS block may be referred to as a “reference” or a “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as the “target” and “reference” (e.g., or “source”), respectively. In such cases, the WTRU may be said to transmit the first (e.g., target) physical channel or signal according to a spatial relation with a reference to the second (e.g., reference) physical channel or signal.

A spatial relation may be implicit, configured by radio resource control (RRC) or signaled by medium access control (MAC) control element (CE) or downlink control information (DCI). For example, a WTRU may implicitly transmit a physical uplink shared channel (PUSCH) and/or a demodulation-reference signal (DM-RS) of the PUSCH according to the same spatial domain filter as a sounding reference signal (SRS). The SRS may be indicated by an SRS resource indicator (SRI) indicated in DCI or configured by RRC. In another example, a spatial relation may be configured by RRC for an SRI or signaled by MAC CE for a physical uplink control channel (PUCCH). Such spatial relation may also be referred to as a “beam indication”.

The WTRU may receive a first (e.g., target) downlink channel or signal according to the same spatial domain filter or spatial reception parameter as a second (e.g., reference) downlink channel or signal. For example, such association may exist between a physical channel such as a PDCCH or PDSCH and its respective DM-RS. At least when the first and second signals are reference signals, such an association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such an indication may also be referred to as a “beam indication”.

Quasi co-location (QCL) assumptions and configurations are considered herein. A WTRU may receive TCI related configuration information. In examples, the TCI related configuration information may comprise a plurality of TCI-states. For example, the TCI related configuration information may include an RRC-configured pool of TCI-states (e.g., as unified TCI framework), a ‘TCI-State’ information element (IE), a ‘TCI-UL-State’ IE, a ‘spatialRelationInfo’ IE, etc. A TCI-state of the plurality of TCI-states may be associated with (e.g., comprised in) a QCL parameter.

For example, a TCI state of the plurality of TCI states may be associated with at least one of QCL-info #1, QCL-info #2, additionalPCI, pathloss RS (PLRS)-ID, UL-PC, Timing Advance Group (TAG)-ID. QCL-info #1 and/or QCL-info #2 may comprise a cell-ID (e.g., serving-cell index), a bandwidth part (BWP)-ID, a RS (e.g., CSI-RS, SSB-index), and/or a QCL-type which may be one of typeA, typeB, typeC, typeD. The PLRS-ID may be for pathloss estimation for determining a UL transmission power when a UL transmission is based on a TCI-state that is associated with the PLRS-ID. The UL-PC (e.g., UL-PC parameter set, which may comprise at least one of P0, alpha, close-loop(CL)-index, power offset, etc.) can be used for determining an uplink power for an UL transmission associated with the TCI-state. In examples, the additionalPCI may be a physical cell-ID (PCID) of a neighboring (e.g., surrounding) cell that the RS is transmitted from. The RS may be associated with the TCI-state. The PCID may be an SSB-index or CSI-RS index. The RS may be transmitted as an inter-cell beam (e.g., or RS) reference.) In examples, the WTRU may apply a timing advance value (e.g., based on received timing advance command(TAC) (s)) in association with the TAG-ID (e.g., of multiple TAG-IDs being configured) to a scheduled UL transmission. QCL typeA may represent {Doppler shift, Doppler spread, average delay, delay spread}, QCL typeB may represent {Doppler shift, Doppler spread}, QCL typeC may represent {Doppler shift, average delay}, and QCL typeD may represent {Spatial Rx parameter}.

When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception. The determined parameter may represent wireless channel characteristics (e.g., at least one of Doppler shift, Doppler spread, average delay, delay spread, Spatial Rx parameter) based on the indicated QCL-type. The WTRU may apply the at least one parameter for transmission or reception of the physical channel or signal.

A unified TCI (UTCI) (e.g., a common TCI, a common beam, a common RS, etc.) may refer to a beam/RS to be (e.g., simultaneously) used for multiple physical channels/signals. The term “TCI” may at least comprise a TCI state that includes at least one source RS to provide a reference (e.g., WTRU assumption) for determining QCL and/or spatial filter.

In examples, a WTRU may receive (e.g., from a gNB) an indication of a first unified TCI to be used/applied for a downlink control channel (e.g., PDCCH), a downlink shared channel (e.g., PDSCH), and/or a downlink RS. The source reference signal(s) in the first unified TCI may provide common QCL information at least for WTRU-dedicated reception on the PDSCH and one or more (e.g., all or a subset of) CORESETs in a control channel (CC). In examples, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant/configured-grant based PUSCH and one or more (e.g., all or a subset of) dedicated PUCCH resources in a CC.

The WTRU may be configured with a first mode for unified TCI (e.g., SeparateDLULTCI mode, a parameter of ‘unifiedTCI-StateType’ set to ‘separate’). An indicated unified TCI (e.g., the first unified TCI or the second unified TCI) may be applicable for either downlink (e.g., based on the first unified TCI) and/or uplink (e.g., based on the second unified TCI).

In an example, a WTRU may receive (e.g., from a base station (BS), a gNB, a transmission/reception point (TRP), etc.) an indication of a second unified TCI to be used/applied commonly for one or more of a PDCCH, a PDSCH, a PUCCH, a PUSCH, a DL RS, and/or a UL RS.

The WTRU may be configured with a second mode for unified TCI (e.g., JointTCI mode, a parameter of ‘unifiedTCI-StateType’ set to ‘joint’). An indicated unified TCI (e.g., the third unified TCI) may be applicable for both downlink and/or uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may include at least PUCCH, PUSCH, and/or SRS. A reception may include at least PDCCH, PDSCH, and/or CSI-RS. A Unified TCI state instance may also be referred to TCI state group, TCI state process, unified TCI pool, a group of TCI states, a set of time-domain instances/stamps/slots/symbols, a set of frequency-domain instances/RBs/subbands, etc. A Unified TCI state instance may be equivalent to or identified by a Coreset Pool identity (e.g., CORESETPoolIndex, a TRP indicator, and/or the like).

Herein, unified TCI may be interchangeably used with one or more of unified TCI-states, unified TCI instance, TCI, and/or TCI-state.

A WTRU may be configured with a plurality of transmission configuration indicator (TCI) states (e.g., unified TCI (UTCI) states), each of which may be applicable for one or multiple channel(s)/signal(s). The multiple channel(s)/signal(s) may be configured to the WTRU or may be pre-determined or defined.

In examples, the multiple channel(s)/signal(s) may be provided in the form of a list, by a higher-layer signaling (e.g., RRC and/or MAC-CE) which may comprise at least one of following (e.g., as a combination). The list may include one or more CORESETs. The list may include one or more PDCCH candidates. The list may include one or more search spaces. The list may include one or more PDSCHs (e.g., PDSCH occasions/configurations/instances, etc.). The list may include one or more RSs (e.g., CSI-RSs, DMRSs, SSB indexes, PRSs, PTRSs, and/or SRSs). The list may include one or more PUSCHs (e.g., PUSCH occasions/configurations/instances, etc.). The list may include one or more PUCCH resources (e.g., PUCCH resource sets/groups). The list may include one or more PRACH occasions/resources/RSs.

The plurality of TCI states may be configured via an RRC signaling (e.g., and/or via a MAC-CE signaling, indication or activation). The WTRU may receive (e.g., via the RRC/MAC-CE or separate signaling) information indicating a mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field. Each of the one or more TCI states may be applicable after a time duration determined based on a beam application time (BAT) parameter.

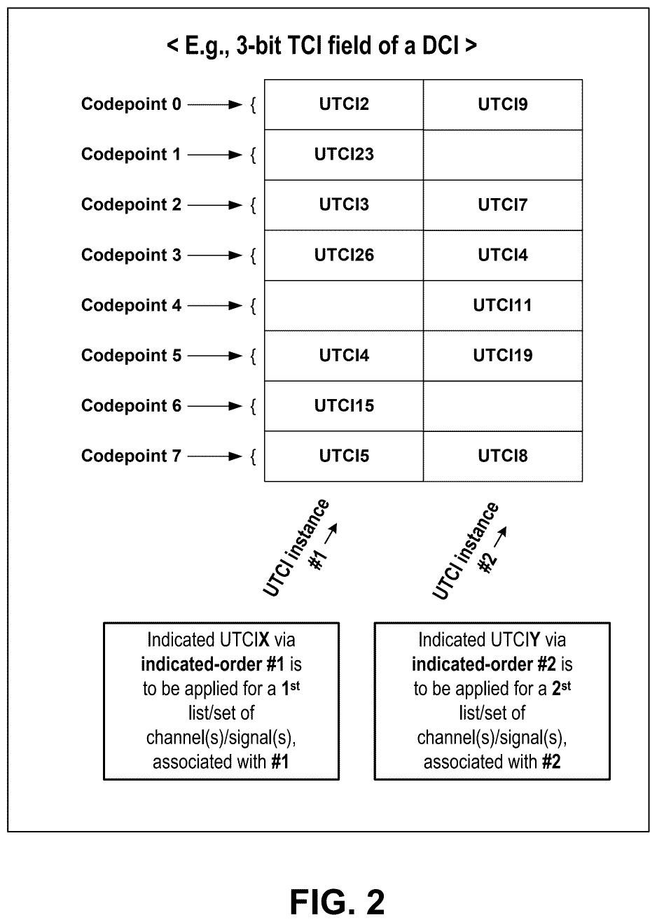

FIG. 2 shows an example of the DCI field (e.g., TCI field) of a DCI for unified TCI-state indications. The WTRU may receive the mapping between a codepoint (e.g., of the DCI field) and one or more TCI states, as illustrated in the FIG. 2. In examples, the WTRU may receive the mapping via MAC-CE signaling. In FIG. 2, Codepoint 2 is mapped to {UTCI3, UTCI7}. In such a case, the WTRU may apply at least one of {UTCI3, UTCI7} to the multiple channel(s)/signal(s) (e.g., based on a list of the multiple channel(s)/signal(s) configurable by a higher layer signaling from a gNB). In examples, the list of the multiple channel(s)/signal(s) may be given per UTCI instance (e.g., TCI-state group, a group of TCI-states, a set of activated TCI-states). The UTCI instance may correspond to each column of the mapping table, as illustrated in FIG. 2, between a codepoint and the one or more TCI states.

Herein, the term transmission and reception point (TRP), may be interchangeably used with one or more of TP (transmission point), RP (reception point), RRH (radio remote head), DA (distributed antenna), BS (base station), a sector (of a BS), and/or a cell (e.g., a geographical cell area served by a BS). Herein, the terms multiple TRP, MTRP and/or M-TRP may be interchangeably used with one another.

The configuration of TRPs, SRIs, and PL reference RS(s) is now considered. A WTRU may be configured with (e.g., may receive configuration of) one or more TRPs to which the WTRU may transmit and/or from which the WTRU may receive. The WTRU may be configured with one or more TRPs for one or more cells. A cell may be a serving cell, secondary cell.

A WTRU may be configured with at least one RS for the purpose of channel measurement. This RS may be denoted as a Channel Measurement Resource (CMR) and may comprise a CSI-RS, SSB, or another downlink RS transmitted from the TRP to a WTRU. A CMR may be configured or associated with a TCI state. A WTRU may be configured with a CMR group where CMRs transmitted from the same TRP may be configured. Each group may be identified by a CMR group index (e.g. group 1). A WTRU may be configured with one or more CMR group per TRP. The WTRU may receive a linkage between one CMR group index and another CMR group index, and/or between one RS index from one CMR group and another RS index from another group.

A WTRU may be configured with (e.g., receive configuration of) one or more pathloss (PL) reference groups (e.g., sets) and/or one or more SRS groups, SRS resource indicators (SRIs), and/or SRS resource sets.

A PL reference group may correspond to or may be associated with a TRP. A PL reference group may include, identify, correspond to, and/or be associated with one or more TCI states, SRIs, reference signal sets (e.g. CSI-RS set, SRI sets), CORESET indexes, and or reference signals (e.g. CSI-RS, SSB).

A WTRU may receive a configuration (e.g., any configuration described herein). The configuration may be received from a gNB and/or TRP. For example, the WTRU may receive configuration of one or more TRPs, one or more PL reference groups and/or one or more SRI sets. A WTRU may implicitly determine an association between a RS set/group and a TRP. For example, if the WTRU is configured with two SRS resource sets, then the WTRU may determine to transmit to TRP1 with SRS in the first resource set, and to transmit to TRP2 with SRS in the second resource set. The configuration may be received via RRC signaling.

In the examples and embodiments described herein, TRP, PL reference group, SRI group, and SRI set may be used interchangeably. The terms set and group may be used interchangeably herein.

CSI components are now considered. A WTRU may report a subset of channel state information (CSI) components, where CSI components may correspond to at least a CSI-RS resource indicator (CRI), a SSB resource indicator (SSBRI), an indication of a panel used for reception at the WTRU (e.g., such as a panel identity or group identity), measurements such as layer 1 (L1)-reference signal received power (RSRP), L1-signal to interference plus noise ratio (SINR) taken from an SSB or CSI-RS (e.g. cri-RSRP, cri-SINR, ssb-Index-RSRP, ssb-Index-SINR), and/or other channel state information such as rank indicator (RI), channel quality indicator (CQI), precoding matrix indicator (PMI), Layer Index (LI), and/or the like.

Properties of a grant or assignment are now discussed. Herein, the properties of a grant or assignment may include at least one of the following. Grant or assignment properties may include a frequency allocation. Grant or assignment properties may include an aspect of time allocation, such as a duration. Grant or assignment properties may include a priority. Grant or assignment properties may include a modulation and coding scheme. Grant or assignment properties may include a transport block size. Grant or assignment properties may include a number of spatial layers. Grant or assignment properties may include a number of transport blocks. Grant or assignment properties may include a TCI state, CRI or SRI. Grant or assignment properties may include a number of repetitions. Grant or assignment properties may include an indication of whether the repetition scheme is Type A or Type B. Grant or assignment properties may include an indication of whether the grant is a configured grant type 1, type 2 or a dynamic grant. Grant or assignment properties may include an indication of whether the assignment is a dynamic assignment or a semi-persistent scheduling (configured) assignment. Grant or assignment properties may include a configured grant index or a semi-persistent assignment index. Grant or assignment properties may include a periodicity of a configured grant or assignment. Grant or assignment properties may include a channel access priority class (CAPC). Additionally, or alternatively, grant or assignment properties may include any parameter provided in a DCI, by MAC or by RRC for the scheduling the grant or assignment.

Herein, an indication by DCI may include at least one of the following. An indication by DCI may include an explicit indication by a DCI field or by RNTI used to mask CRC of the PDCCH. An indication by DCI may include an implicit indication by a property such as DCI format, DCI size, Coreset or search space, Aggregation Level, the first resource element of the received DCI (e.g., index of first Control Channel Element). The mapping between the property and the value may be signaled by RRC or MAC.

Herein, the term, “signal” may be interchangeably used with one or more of following: Sounding reference signal (SRS); Channel state information - reference signal (CSI-RS); Demodulation reference signal (DM-RS); Phase tracking reference signal (PT-RS); Synchronization signal block (SSB).

Herein, the term, “channel” may be interchangeably used with one or more of following: Physical downlink control channel (PDCCH), Physical downlink shared channel (PDSCH), Physical uplink control channel (PUCCH), Physical uplink shared channel (PUSCH), Physical random access channel (PRACH), etc.

Herein, downlink reception may be used interchangeably with Rx occasion, PDCCH, PDSCH, SSB reception,.

Herein, the term, “uplink transmission” may be used interchangeably with Tx occasion, PUCCH, PUSCH, PRACH, SRS transmission.

Herein, the term, “RS” may be interchangeably used with one or more of RS resource, RS resource set, RS port and RS port group. Herein, the term RS may be interchangeably used with one or more of SSB, CSI-RS, SRS and DM-RS.

Herein, the term, “time instance” may be interchangeably used with slot, symbol, subframe.

Herein, the term UTCI may be interchangeably used with TCI, UTCI state, TCI state.

A WTRU may be configured to perform early CSI-RS measurement and CSI reporting. In examples, the WTRU may perform one or more of the following actions.

Early CSI measurement and/or reporting may refer to CSI measurement or reporting that are performed by a WTRU at any point before the WTRU sends a CSI and/or beam report (e.g., ordinary CSI-RS measurement and/or reporting) while in RRC_CONNECTED mode, in accordance with the RRC configuration for CSI-RS provided to the WTRU by the base station. In examples, as described more thoroughly below, early CSI measurement and/or reporting may be performed in association with a random access procedure (e.g., 2-step or 4-step RACH). Early CSI measurement and/or reporting may be performed after completion of a RACH procedure, but before ordinary CSI-RS measurement or reporting. Early CSI measurement and/or reporting can be performed while the WTRU is in an inactive or dormant state. For example, early CSI measurement or reporting can be performed while the WTRU is in a discontinuous transmission (DTX) or discontinuous reception (DRX) mode. The early CSI measurement and/or reporting may be independent of DTX or DRX procedures, or may be coordinated with the DRX/DTX cycles.

A WTRU may detect an SS block (SSB) and/or SSB index. The WTRU may detect the SSB (e.g., index) based on receiving system information (e.g., MIB, SIB). The WTRU may transmit a physical random access channel (PRACH) message (e.g., Msg1) based on the SSB index, as a part of a random access (RA) procedure for transition from the RRC-idle or RRC-inactive state to the RRC-connected state. In examples, the WTRU may perform this step in response to receiving a paging signal from a gNB.

The system information may include configuration of one or more tracking RSs (TRSs) resources. The configuration information for the one or more of the TRSs may include (e.g., for each TRS) time and/or frequency resource information for WTRU to receive a TRS. The TRSs may have no association with any SSB index.

The WTRU may receive a DCI and/or a random access response (RAR) scheduled by the DCI (e.g., RA Msg2). The RAR may comprise at least one of a RA preamble identifier (e.g., matched to the PRACH), a temporary C-RNTI (TC-RNTI), a timing advance command, a UL grant (e.g., for a PUSCH or Msg3) for WTRU to transmit, and/or one or more parameters for early CSI reporting.

The parameters for early CSI reporting may include an indication of a resource for early CSI measurement. For example, a first indication of a tracking RS (TRS). In examples, the indication of a TRS may point to one of the TRS resources configured by the system information or may point to a CSI resource or CSI-RS resource set (e.g., configured with trs-Info) that is configured as a part of discontinuous reception (DRX) configuration or system information. The DRX configuration may be configured by the system information.

The parameters for early CSI reporting may include an M-bit field (e.g., M=1 or 2), indicating to the WTRU whether or not to transmit an early CSI report and/or in what PUSCH or message to send it. For example, the field may indicate to send the early CSI report in or along with the PUSCH or Msg3 (e.g., scheduled by the UL grant), or via a later UL transmission (e.g., after receiving an RRC setup message or an RRC resume message, which may be in a Msg4). The field may indicate to send the early CSI report in or along with another message (e.g., Msg5) which may include an RRC reconfiguration-complete or RRC setup-complete message.

In examples, the field may indicate time(s) and/or event(s) after which the WTRU should perform early CSI reporting. For example, when the field is M=2 bits long, the combination of two bits could signal the WTRU with information similar to the following example: {‘00’: No early CSI reporting, ‘01’: Early CSI reporting in Msg3, ‘10’: Early CSI reporting after Msg3, ‘11’: Early CSI reporting in both Msg3 and after Msg3}.

When the WTRU is configured or indicated (e.g., by the RAR) to transmit an early CSI report, the WTRU may determine CSI based on or according to TRS based operations, and/or default operations.

For TRS-based operations, the WTRU may determine CSI based on the indicated TRS resource. The WTRU may determine that the TRS resource (e.g., indicated by the first indication) has a quasi-co-location(QCL) association (e.g., at least in terms of QCL-typeC and/or QCL-typeD), with the SSB/SSB index (e.g., detected in the SI and/or used in the Msg1 transmission). The QCL association may, for example, indicate a QCL-typeC relationship, indicating a Doppler shift and/or average delay, or a QCL-typeD relationship, indicating a spatial Rx parameter.

The WTRU may determine CSI for a TRS (e.g., a 1-port TRS) received in the TRS resource. The WTRU may determine the CSI for the TRS based on at least the QCL association determined for the TRS. The CSI may comprise at least a value of channel quality indicator (CQI, e.g., 4-bits). This CQI value may be from a defined or pre-configured CQI table, and/or derived based on measuring the TRS (e.g., 1-port TRS). Herein, TRS-based operation may be referred to as operation mode 1.

For operations in a default mode, (e.g., defined as a default mode of early CSI reporting), the WTRU may determine CSI based on the SSB and/or the PBCH DMRS associated with the SSB. In such cases, the parameters for early CSI reporting comprised in the RAR may include an indication (e.g., implicit or explicit) that the SSB and/or a Physical Broadcast Channel (PBCH) demodulation reference signal (DMRS) associated with the SSB should be used as a resource for early CSI measurement. The WTRU may measure the SSB and/or the associated PBCH DMRS. The CSI may comprise at least a value of CQI, derived based on (e.g., based on measuring) the SSB (e.g., 1-port SSB) and/or the PBCH DMRS associated with the SSB. Herein, this default mode operation may be referred to as operation mode 2.

For operation mode 1 or operation mode 2, the CSI may be determined by measuring the CSI resource indicated in the RAR (e.g., the TRS for mode 1 or the SSB/PBCH DMRS for mode 2). The measurement of the CSI resource may be a layer 1 (L1) RSRP measurement and/or a L1 signal to interference plus noise ratio (SINR). Determining the CRI may also comprise determining a rank indicator (RI), a precoding matrix indicator (PMI), a CSI-RS reference indicator (CRI), or etc.

When the WTRU is configured or indicated (e.g., by the RAR) to transmit an early CSI report, the WTRU may transmit the early CSI report including the determined CSI (e.g., from Operation mode 1 or Operation mode 2) as discussed below.

The WTRU may transmit a PUSCH (e.g., Msg3, RRC connection or resume request) or an associated UL transmission, scheduled by the UL grant (e.g., given by the RAR). The contents of the PUSCH may comprise at least one of the operation mode 1 determined TRS-based CSI (e.g., CQI) or the operation mode 2 determined CSI (e.g., CQI) based on the SSB and/or the PBCH DMRS associated with the SSB.

The WTRU may transmit a PUSCH (e.g., Msg5, RRC setup complete or RRC reconfiguration complete). The contents of the PUSCH may comprise at least one of the operation mode 1 determined TRS-based CSI (e.g., CQI) or the operation mode 2 determined CSI (e.g., CQI) based on the SSB and/or the PBCH DMRS associated with the SSB.

In examples, the WTRU may receive a second DCI and/or a PDSCH message (e.g., RRC setup message, e.g., Msg4, or a separate DL message). The PDSCH message may be scheduled by the second DCI. The PDSCH may (e.g., further) comprise at least one of following.

The PDSCH may include a second indication of one or more CSI-RS resources (e.g., from a plurality of CSI-RS resources that are configured as a part of discontinuous reception (DRX) configuration or configured via system information). This information may enable multi-port CSI-RS based early CSI measurement and reporting, which is referred to as mode 3, herein.

The PDSCH may include an N-bit field (e.g., N=1), indicating to the WTRU whether or not to transmit an early CSI reporting after Msg3 (e.g., after Msg4 of RRC reconfiguration-complete or setup-complete message) or a separate UL transmission. For example, when N=1, it may signal information similar to the following to the WTRU:
{‘0’: No early CSI reporting, ‘1’: Early CSI reporting after Msg3 or via a separate UL transmission}.

The WTRU may transmit a second PUSCH (e.g., Msg5) or an associated UL transmission (e.g., associated with a paging message being received), indicated by the PDSCH (e.g., in Msg4 and/or by the RAR, for example, if ‘11’ of the M-bit field is indicated). The contents of the second PUSCH may comprise at least one of the following.

The second PUSCH may comprise early CSI reporting data which includes at least one of a CSI-RS resource indicator (CRI), a rank indicator (RI), a precoding matrix indicator (PMI), and/or a value of CQI. These values may be derived based on measuring the one or more CSI-RS resources, (e.g., based on the QCL association with the SSB and/or the TRS). For operation mode 3, these values may be derived based on multi-port CSI-RS measurements. In examples, one or more (e.g., each) of the CSI-RS resources may be K-port (e.g., multi-port) CSI-RS resources, where K=1, 2, 4, 8, 16, or 32, etc.

Paging procedures and early CSI reporting behavior when transitioning to RRC-connected state are considered herein. When a WTRU is in idle-state or in inactive-state, the gNB may use paging mechanisms to locate and initiate an RRC connection set up. WTRU may determine paging occasions based on the broadcasted periodicities in system information messages (e.g., SIB1) and/or a WTRU-related ID (e.g., temporary identifier). Once a WTRU determines the configured paging occasions, it may monitor PDCCH activities (e.g., detect a DCI transmitted for the WTRU) in the determined windows. The WTRU may decode and act on a DCI (e.g., where the DCI's CRC is scrambled by an assigned P-RNTI).

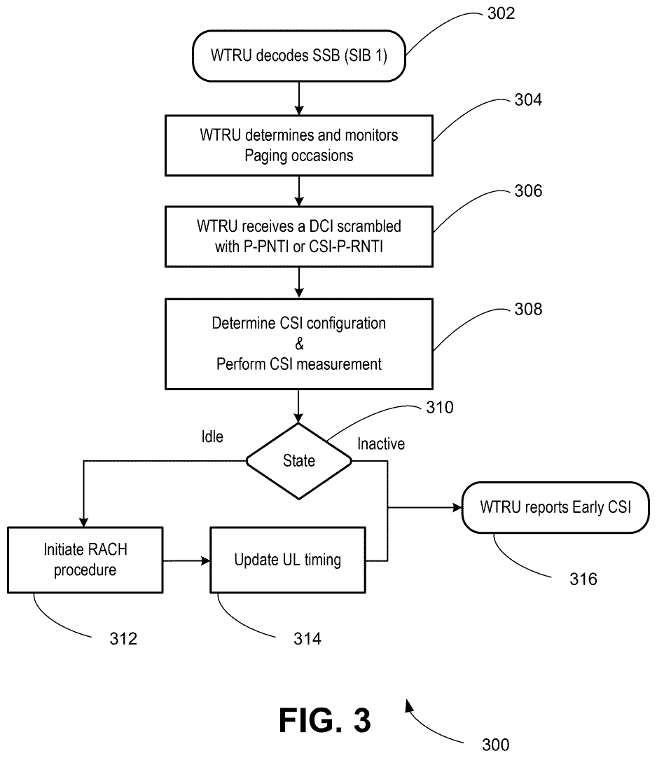

FIG. 3 shows an example solution that uses paging procedures for early CSI measurement and reporting at 300. At 302, the WTRU may decode an SSB (e.g., SIB 1). At 304, the WTRU may determine and monitor paging occasions. At 306, the WTRU may receive a DCI scrambled with P-PNTI or CSI-P-RNTI. At 308, the WTRU may determine a CSI configuration and/or perform CSI measurement. At 310, if the WTRU is in idle state, it may determine to initiate a RACH procedure at 312. Subsequently, the WTRU may update UL timing at 314, and report early CSI at 316. Alternatively, if the WTRU is in the inactive state at 310, the WTRU may proceed to report early CSI at 316 without performing the steps of initiating the RACH procedure at 312 or updating UL timing at 314.

When a WTRU receives a DCI (e.g., with its CRC scrambled by an assigned RNTI, such as P-RNTI, or a separate RNTI such as CSI-P-RNTI, or a dedicated early-CSI-trigger-RNTI such as CSI-RNTI), a WTRU may perform one or more of the following actions.

In examples, if the WTRU is in the inactive state, the WTRU may use an indication in the DCI to trigger CSI measurement and reporting and perform one or more of the following steps. The WTRU may identify at least one CSI resources for CSI measurement (e.g., by explicit indication of a CSI resource, by a pointer to a preconfigured CSI resource, etc.). The WTRU may identify at least one measurement quantity for CSI measurement (e.g., by explicit indication of a measurement quantity, a pointer to a preconfigured measurement quantity, etc.). The WTRU may identify at least one UL RS transmission trigger (e.g., triggering indication to transmit at least one SRS with corresponding SRS configuration, for channel-reciprocity based CSI acquisition at the network). The WTRU may determine corresponding uplink resources for reporting, (e.g., a PUSCH grant, a PUCCH resource, etc.).

Additionally, or alternatively, if the WTRU is in the inactive state, a WTRU may use an indication in the DCI to trigger a CSI measurement and reporting, and perform a PDSCH reception (e.g., scheduled by the DCI). The PDSCH may comprise one or more of the following. The PDSCH may comprise information for WTRU to identify at least one CSI resources for CSI measurement (e.g., by explicit indication of a CSI resource, by a pointer to a preconfigured CSI resource, etc.), The PDSCH may comprise information for WTRU to identify at least one measurement quantity for CSI measurement (e.g., by explicit indication of a measurement quantity, a pointer to a preconfigured measurement quantity, etc.). The PDSCH may comprise information for WTRU to identify at least one UL RS transmission trigger (e.g., triggering indication to transmit at least one SRS with corresponding SRS configuration, for channel-reciprocity based CSI acquisition at the network). The PDSCH may comprise information for WTRU to determine corresponding uplink resources for reporting (e.g., a PUSCH grant, a PUCCH resource, etc.).

If the WTRU is in the idle state, the WTRU may perform the following (e.g., separate) processes. The WTRU may use an indication in the DCI to trigger CSI measurement and reporting. The WTRU may initiate a RACH process (e.g., 2-step or 4-step RACH). The RACH process may at least allow the WTRU to acquire updated uplink timing. The WTRU may perform CSI measurement and reporting based on one or more of the followings actions.

The WTRU may use an indication in the DCI to identify at least one CSI resources for CSI measurement (e.g., by explicit indication of a CSI resource, a pointer to a preconfigured CSI resource, etc.). The WTRU may use an indication in the DCI to identify at least one measurement quantity for CSI measurement (e.g., by explicit indication of a measurement quantity, a pointer to a preconfigured measurement quantity, etc.). The WTRU may use an indication in the DCI to identify at least one UL RS transmission trigger (e.g., triggering indication to transmit at least one SRS with corresponding SRS configuration, for channel-reciprocity based CSI acquisition at the network). The WTRU may use an indication in the DCI to determine corresponding uplink resources for reporting (e.g., a PUSCH grant, a PUCCH resource, etc.).

Alternatively, or additionally, a WTRU may use an indication in the DCI to perform a PDSCH reception (e.g., scheduled by the DCI). The PDSCH may comprise one or more of the following.

The PDSCH may comprise information for WTRU to identify at least one CSI resources for CSI measurement (e.g., by explicit indication of a CSI resource, a pointer to a preconfigured CSI resource, etc.). The PDSCH may comprise information for WTRU to identify at least one measurement quantity for CSI measurement (e.g., by explicit indication of a measurement quantity, a pointer to a preconfigured measurement quantity, etc.). The PDSCH may comprise information for WTRU to identify at least one UL RS transmission trigger (e.g., triggering indication to transmit at least one SRS with corresponding SRS configuration, for channel-reciprocity based CSI acquisition at the network). The PDSCH may comprise information for WTRU to determine corresponding uplink resources for reporting (e.g., a PUSCH grant, a PUCCH resource, etc.).

In examples, a WTRU may be assigned a special RNTI (e.g., CSI-P-RNTI, CSI-RNTI) to flag a received DCI (e.g., in a paging occasion as an early CSI request trigger). Therefore, when a WTRU receives a DCI with its CRC scrambled by an assigned CSI-P-RNTI (e.g., CSI-RNTI), the WTRU may trigger an early CSI measurement and reporting procedure using one or more of the steps described herein.

Configuration of early CSI reporting is considered herein. A WTRU may receive semi-static and/or dynamic (e.g., by RRC, MAC-CE, and/or DCI) configurations for early CSI reporting that may indicate one or more of the following.

The configurations for early CSI reporting may indicate one or more physical cell identification numbers (PCI). The configurations for early CSI reporting may indicate one or more temporary cell-radio network identifiers (TC-RNTI). The configurations for early CSI reporting may indicate one or more cell radio network identifiers (C-RNTI). The configurations for early CSI reporting may indicate a special early-CSI-reporting indicator (e.g., ECRI) or a special RNTI for early CSI reporting (e.g., CSI-RNTI, CSI-P-RNTI).

The configured or indicated PCI, TC-RNTI, C-RNTI, ECRI, CSI-RNTI may be used by the gNB as an implicit indication to the WTRU to report the early CSI (e.g., when it wakes up or switches from an in-active or idle state to another state, such as the RRC-connected state).

One or more of the above-mentioned (e.g., PCI, TC-RNTI, C-RNTI, ECRI, CSI-RNTI, etc.) may be valid for a semi-statically or dynamically configured and/or indicated time window or pattern of time windows. One or more of the above-mentioned may be associated with a time-window or a pattern of time-window. The time-window or pattern of time windows may begin from one or more of the following.

The time-window or pattern of time windows may begin from the instance when a WTRU switches from RRC connected or RRC idle state. The time-window or pattern of time windows may begin from the instance when a WTRU switches from RRC connected to RRC inactive state. The time-window or pattern of time windows may begin from the instance when a WTRU switches from RRC idle to RRC connected state. The time-window or pattern of time windows may begin from the instance when a WTRU switches from RRC idle to RRC inactive state. The time-window or pattern of time windows may begin from the instance when a WTRU switches from RRC inactive to RRC connected state. The time-window or pattern of time windows may begin from the instance when a WTRU switches from RRC inactive to RRC idle state.

Additionally, or alternatively, the time-window, (e.g., the starting time stamp and the ending time stamp of the time-window) or the pattern of time windows may be semi-statically or dynamically configured and/or indicated to the WTRU. For example, the WTRU may receive a DCI that includes an existing or a new field that indicates a time window or a pattern of time windows.

One or more PCI, TC-RNTI, ECRI, CSI-RNTI, and/or C-RNTI may be associated with the time-window or a pattern of time-windows. The PCI, TC-RNTI, ECRI, CSI-RNTI, and/or C-RNTI in a time-window or a pattern of time window may be associated with one or more report quantities (e.g., CSI-RS resource indicator (CRI), rank indicator (RI), precoding matrix indicator (PMI), channel quality indicator (CQI), layer1(L1)-RSRP, L1-SINR, etc.). The association between or among PCI, TC-RNTI, ECRI, CSI-RNTI, C-RNTI, time-window, pattern of time-windows, and report quantities may be semi-statically or dynamically configured and/or indicated to the WTRU.

In examples, the first window in a pattern of time-windows may be associated with second order channel statistics (e.g., auto-correlation of the channel, Doppler shift, Doppler spread, time-domain channel properties (TDCP), etc.) The second window in a pattern of time-windows may be associated with channel quality information (e.g., wideband CQI and/or sub-band CQI). The third window in the patter of time-windows may be associated with precoding information (e.g., precoding matrix indicator (PMI)). A first PCI in a first time-window in a pattern of time windows may be associated with TDCP. TC-RNTI and/or C-RNTI in a third time-window in a pattern of time windows may be associated with wideband CQI.

WTRU behavior during the time-window or the pattern of time-windows is now considered. The WTRU may perform CSI determination. The term, “early connection state” may refer to a condition when the WTRU obtains the PCI, or receives TC-RNTI, ECRI, CSI-RNTI and/or C-RNTI, and/or switches from RRC-idle (or RRC-inactive) state to RRC-connected state. When the WTRU is in early connection state, within the time-window or within the pattern of time-windows, the WTRU may determine a CSI based on the configured set of PCI, TC-RNTI, ECRI, CSI-RNTI and/or C-RNTI and time-windows.

For example, when the WTRU switches from RRC-inactive or RRC-idle state to RRC-connected state or when the WTRU is triggered by the gNB to switch from RRC-inactive or RRC-idle state to RRC-connected state, the WTRU may be in early connection state. The WTRU may determine a report quantity based on the associated time-window and PCI, TC-RNTI, ECRI, CSI-RNTI and/or C-RNTI.

For example, the WTRU may switch from RRC-inactive or RRC-idle state to RRC-connected state and may be in the time-window that is associated with TDCP reporting (e.g., based on a function of at least one of PCI, TC-RNTI, ECRI, CSI-RNTI and/or C-RNTI). Then, the WTRU may determine TDCP and report CSI comprising the determined TDCP.

For example, the WTRU may switch from RRC-inactive or RRC-idle state to RRC-connected state and may be in the time-window that is associated with beam reporting (e.g., based on a function of at least one of PCI, TC-RNTI, ECRI, CSI-RNTI and/or C-RNTI). Then, the WTRU may determine one or more measurements (e.g., CRI, L1-RSRP, and/or L1-SINR) and report CSI comprising the determined one or more measurements (e.g., CRI, L1-RSRP, and/or L1-SINR).

For example, the WTRU may switch from RRC-inactive or RRC-idle state to RRC-connected state and may be in the time-window that is associated with CSI feedback (e.g., based on a function of at least one of PCI, TC-RNTI, ECRI, CSI-RNTI and/or C-RNTI). Then, the WTRU may determine one or more measurement value (e.g., CRI, RI, PMI, and/or CQI) and report CSI comprising the determined one or more measurement value (e.g., CRI, RI, PMI, and/or CQI).

The WTRU may perform measurements of measurement resources to determine CSI. When the WTRU is in the early connection state, with in a time-window or within the pattern of time windows, the WTRU may use the SSB(s), (e.g., the primary synchronization signal (PSS), the secondary synchronization signal (SSS)), and/or the physical broadcast channel (PBCH) (e.g., the de-modulation reference signal (DMRS) in PBCH) as the measurement resources for CSI determination.

In examples, the WTRU may use the burst of PSS, SSS and/or PBCH to determine TDCP that represents long-term channel statistics of the channel. The WTRU may use the burst of PSS, SSS and/or PBCH to determine CQI and/or a PMI (e.g., wideband PMI).

A WTRU may have access (e.g., comprise) to computational resources for CSI determination. A WTRU may declare or send to the gNB an indication of its computational capabilities in one or more carriers (e.g., and/or BWPs). The indication of the WTRU's computational capabilities may indicate support for determination of early CSI (e.g., during the early connection state).

For example, the WTRU may declare that it supports M number of computational units on a given carrier (e.g., and/or BWP) that it may use for determination of a particular CSI (e.g., for determination of one or more of CRI, RI, PMI, CQI, L1-RSRP, L1-SINR, and/or TDCP) during the early connection state.

A WTRU may declare or send to the gNB an indication of its computational capabilities that can be used across different carriers (e.g., and/or BWPs), that can be shared across different carriers (e.g., and/or BWPs).

For example, the WTRU may send an indication that it supports M1 number of computational resources on a first carrier (e.g., and/or BWP) and M2 number of computational units on a second carrier (e.g., and/or BWP). The WTRU may also indicate that it supports M1+M2 number of computational resources on the first and/or the second carrier (and/or BWP).

Based on the computational resource's capability of the WTRU, it may declare the earliest time (e.g., the earliest time in the early connection state when it may be able to send the CSI).

For example, the WTRU may declare that it can support sending one or more measurements (e.g., of CRI, RI, PMI, CQI, L1-RSRP, L1-SINR, and/or TDCP) as early as Msg1, Msg3, and/or some time period or instant after Msg3.

A WTRU may perform CSI reporting. The gNB may assign uplink resources to the WTRU for reporting the early CSI that is determined during the early connection state. The number of uplink resources, (e.g., the number of resource elements or resource blocks, the time and frequency indexes of the resources) may be associated with one or more of the following.

The number of uplink resources may be associated with the PCI, TC-RNTI, ECRI, CSI-RNTI, C-RNTI, time-window, pattern of time windows, and/or report quantity. For example, when PCI=1, C-RNTI=4, the time-window is the 7^{th} time window in a pattern of time-windows, and the associated report quantity is TDCP, the WTRU may use the first resource block at the third symbol of the first slot.

The WTRU may send a report using the uplink resources determined using one or more of the above-mentioned parameters. The report may include indications for the determined report quantity.

Early CSI reporting may be associated with a random-access procedure. A WTRU may determine to initiate a random access (e.g., initial access) procedure (e.g., starting with transmitting a PRACH, such as Msg1 or MsgA), when at least one of following conditions are met.

A WTRU may determine to initiate a random access procedure when the WTRU powers on and for the first time tries to connect to the network (e.g., as a part of an initial connection establishment process, and/or when the WTRU is establishing an RRC connection with a base station (BS) such as a gNB). A WTRU may determine to initiate a random access procedure in relation to a handover procedure (e.g., when a cell, such as a serving-cell and/or a target gNB, requires the WTRU to do the random access to establish synchronization). A WTRU may determine to initiate a random access procedure when the WTRU has buffered uplink data (e.g., in UL buffer) to send but no assigned (e.g., or no valid) uplink resource (e.g., via a PUSCH) is given or identified. A WTRU may determine to initiate a random access procedure when the WTRU detects a condition that represents a loss of synchronization with a gNB (e.g., the serving-gNB). The condition may include a failure to decode a DL RS, in relation to a radio link failure (RLF) procedure, and/or in relation to a beam failure recovery (BFR) procedure. A WTRU may determine to initiate a random access procedure when the WTRU (e.g., in an RRC-idle state), receives (e.g., detects, decodes) a paging message from the network, and the WTRU is required to respond (e.g., to the paging message) with the RA procedure. A WTRU may determine to initiate a random access procedure when the WTRU needs to access or re-obtain (e.g., update) system information. A WTRU may determine to initiate a random access procedure when the WTRU transitions from RRC-inactive state or RRC-idle state to RRC-connected state. These are merely examples of when a WTRU may determine to initiate a random access procedure and are not limiting.

The WTRU may receive system information (e.g., MIB, SIB) and configurations to transmit the PRACH as a part of 4-step RACH procedure. The WTRU may transmit the PRACH as a first step signal transmission (e.g., Msg1). In response to transmitting the PRACH, the WTRU may monitor a response from the network (e.g., by monitoring for a DCI indicating a random access response (RAR) which includes a UL scheduling grant for the WTRU to transmit in return. The WTRU may transmit a PUSCH (e.g., Msg3) based on the UL scheduling grant and a timing advance command given by the RAR. The WTRU may receive a confirmation message (e.g., RRC setup, Msg4, RRC establishment complete message) via a PDSCH. The WTRU may send a feedback message (e.g., ACK, HARQ-ACK, Msg5) in response to receiving the confirmation message.

In order for the WTRU to receive downlink data (e.g., and/or transmit uplink data) based on accurate channel state information (CSI), the WTRU may need to measure a DL RS (e.g., TRS and/or CSI-RS) for CSI (e.g., or beam) measurement. Based on the measurement, the WTRU may need to report CSI (e.g., or beam) reporting. The confirmation message (e.g., Msg4) and/or a subsequent DL control message may configure the necessary CSI (e.g., or beam) measurement related information/parameters, and a large latency may be identified (e.g., expected) until the WTRU reports the CSI (e.g., or beam) reporting contents based on the measurement.

In examples, at least one component and/or parameter related to the CSI (e.g., or beam) measurements and corresponding CSI (e.g., or beam) reporting procedure (e.g., including at least one behavior for early CSI reporting as discussed herein, including behaviors based on early connection state, etc.), may be associated with a part of the random access procedure (e.g., the 4-step RACH procedure, or a 2-step RACH procedure, etc.).

Operations related to RACH Msg1 are considered herein. The WTRU may be in an RRC-idle or RRC-inactive state. The WTRU may determine to transition to RRC-connected state (e.g., based on at least one of the conditions discussed herein). The WTRU may detect (e.g., measure, receive) an SSB with a corresponding SSB index, and determine a RACH occasion (RO) associated with the SSB (e.g., of a plurality of ROs being configured). For example, the WTRU may determine the RO via system information such as MIB, and/or SIB. The RO may include a time and/or frequency domain resource which the WTRU may use to transmit a PRACH. Determining the RO being associated with the SSB may be based on a pre-defined or pre-configured rule (e.g., an SSB-to-RO mapping rule).

If the WTRU determines a quality of the SSB is above a threshold, (e.g., when a measured RSRP, such as a layer3-filtered RSRP, Layer1(L1)-RSRP of the SSB is above a pre-defined or configured RSRP threshold), the WTRU may transmit a PRACH by using the determined RO.

Operations related to RACH Msg2 are considered herein. The WTRU may receive a DCI and random access response (RAR) scheduled by the DCI (e.g., including a Msg2). The RAR may comprise a RA preamble identifier (e.g., matched to the PRACH), a temporary C-RNTI (e.g., or TC-RNTI), a timing advance command, a UL grant of Msg3 for WTRU to transmit, and/or one or more parameters for early CSI reporting. The parameters for early CSI reporting may differ from case to case. Examples of several cases are discussed below.

In some cases (e.g., referred to herein as case 1), the parameters for early CSI reporting may include a first indication of a tracking RS (TRS). The first indication of a TRS may point to one or more CSI-RS resource set (e.g., configured with trs-Info). In some cases, the CSI-RS resource set may be configured during the previous RRC-connected state (e.g., where the WTRU got released by a serving cell, possibly the same serving-cell) from the previous RRC-connected state while keeping information such as one or more TRS configurations. In some cases, the CSI-RS resource set may be configured as a part of discontinuous reception (DRX) configuration.

In some cases (e.g., referred to herein as case 2), the parameters for early CSI reporting may include a second indication of one or more CSI-RS resources. The second indication of one or more CSI-RS resources may be from a plurality of CSI-RS resources that was configured during the previous RRC-connected state (e.g., where the WTRU got released by the same or a different serving-cell). The WTRU may have kept information such as the one or more CSI-RS resource configurations from the previous RRC-connected state. In examples, the second indication may indicate a CSI-RS resource from a plurality of CSI-RS resources that were configured as a part of discontinuous reception (DRX) configuration.

In some cases (e.g., referred to herein as case 3), the parameters for early CSI reporting may include an M-bit field (e.g., M=1 or 2) indicating whether or not the WTRU to transmit an early CSI reporting along with Msg3. The M-bit field may be included in a reserved field (e.g., ‘CSI request field’) in the RAR. The M-bit field may indicate whether the WTRU should transmit an early CSI report along with Msg3, (e.g., scheduled by the UL grant), or via a UL transmission after Msg4 (e.g., an RRC setup message). Additionally, or alternatively, the M-bit field may indicate whether the WTRU should send the early CSI report along with a (e.g., separate) UL transmission, such as a Msg5, RRC reconfiguration-complete or setup-complete message, etc.

In examples, when M=2, the field may provide information based on whether or not each of the bits is set, for example: {‘00’: No early CSI reporting, ‘01’: Early CSI reporting in Msg3, ‘10’: Early CSI reporting after Msg3, ‘11’: Early CSI reporting in both Msg3 and an UL transmission after Msg3}. In another example, when M=2, the bit values may correspond to: {‘00’: No early CSI reporting, ‘01’: Early CSI reporting in Msg3, ‘10’: Early CSI reporting in Msg5, ‘11’: Early CSI reporting in both Msg3 and Msg5}.

The system information (e.g., received before transmitting the Msg1) may include configuration information for one or more tracking RSs (TRSs) resources The configuration information may include time and/or frequency resource information for WTRU to receive for one or more (e.g., each of the) TRS resource. The TRS resources may have no association with any SSB index.

The system information (e.g., received before transmitting the Msg1) may include configuration information for the plurality of CSI-RS resources. The configuration information may indicate time and/or frequency resource information for WTRU to receive a CSI-RS with no association with any TRS (e.g., and/or any SSB index).

A WTRU may be configured for early CSI derivation based on the indicated TRS. The WTRU may determine CSI based on the indicated TRS (e.g., on condition that the Case 1 is indicated). The WTRU may determine that the TRS resource (e.g., by the first indication) has a quasi-co-location(QCL) association (e.g., at least in terms of QCL-typeC and/or QCL-typeD) with the SSB index detected or used in the Msg1 transmission. QCL-typeC may comprise a relationship involving Doppler shift and/or average delay}, and QCL-typeD may comprise a relationship involving Spatial Rx parameter(s).

The WTRU may determine the CSI. The CSI may at least comprise a value of channel quality indicator (CQI, e.g., 4-bits). The CQI may be derived from a defined or pre-configured CQI table (e.g., derived based on measuring the 1-port TRS).

On condition that the Case 2 (e.g., and/or well as Case 1) is indicated, the WTRU may determine CSI based on measuring the indicated one or more CSI-RS resources (e.g., based on the QCL association with the SSB and/or the TRS if Case 1 is also indicated). For example, each of the CSI-RS resource may be a K-port (multi-port) CSI-RS resource. K may have possible values of 1, 2, 4, 8, 16, or 32, and so on. The WTRU may determine the CSI which may comprise one of the following.

The CSI may comprise a CSI-RS resource indicator (CRI), which selects at least one of the one or more CSI-RS resources. The CSI may comprise a Rank indicator (RI) (e.g., 2 or 3 bits). The CSI may comprise one or more precoding matrix indicator (PMI)s (e.g., 1, 2, 3, or 4 bits, and so on.) (from a defined or pre-configured codebook). The CSI may comprise one or more CQIs. The CQIs may be derived based on measuring the one or more CSI-RS resources. A first CQI (e.g., 4-bits) of the CQIs may be from a first defined or pre-configured CQI table and a second CQI (e.g., a differential CQI, e.g., 3-bits) of the CQIs may be from a second defined or pre-configured CQI table. The second CQI (e.g., as a differential CQI) may be calculated based on the first CQI (e.g., the difference between them may be captured in entries of the second CQI table).

Early CSI derivation may be based on a “default RS” (e.g., SSB, PBCH DMRS). The WTRU may be configured to use the “default RS” in a default mode of early CSI reporting). The WTRU may determine CSI based on the SSB detected or used in the Msg1 transmission and/or the PBCH DMRS associated with the SSB. The WTRU may determine the CSI. The CSI may at least comprise a value of CQI (e.g., 4-bits). The CQI may be derived from a defined or pre-configured CQI table. The CQI may be derived based on measuring the SSB and/or the PBCH DMRS associated with the SSB, and/or at least one report quantity discussed herein, based on the early connection state and/or the time-window.

The WTRU may determine the CSI which may at least comprise an RSRP value. The RSRP value may, for example, comprise a value of SSB-RSRP (e.g., 7-bits). The RSRP value may be derived from a defined or pre-configured RSRP table. The RSRP value may be derived based on measuring the SSB and/or the PBCH DMRS associated with the SSB, and/or at least one report quantity discussed herein, based on the early connection state and/or the time-window.

In examples, the WTRU may receive Information to identify at least one UL RS transmission trigger (e.g., a triggering indication to transmit at least one SRS with a corresponding SRS configuration, for channel-reciprocity based CSI acquisition at the network). The information may be associated with (e.g., comprised in) the RAR or delivered via a separate message. In response to the information, the WTRU may transmit one or more SRSs. The network may acquire, by receiving (e.g., and/or measuring) the transmitted SRS, a part of the necessary early CSI component (e.g., beam direction, PMI, precoding information, precoder, etc.). The part of the necessary early CSI component may be combined with the WTRU's early CSI reporting contents (e.g., CQI, L1-RSRP, etc.) to obtain necessary early CSI information.

Operations related to RACH Msg3 are discussed herein. The WTRU may transmit a PUSCH (e.g., RRC connection request, Msg3, etc.) or an associated UL transmission, scheduled by the UL grant (e.g., provided by the RAR). The PUSCH may comprise at least one of the following.

The PUSCH may comprise early CSI reporting contents (e.g., on condition that Case 1 and/or ‘01’ or ‘11’ of the M-bit field) is indicated. The early CSI reporting contents may be determined based on measuring the indicated TRS (e.g., based on the QCL association with the SSB). The early CSI reporting contents may include a value of channel quality indicator (CQI) (e.g., from a defined or pre-configured CQI table, derived based on measuring the 1-port TRS, and/or derived based on the SSB and/or the PBCH DMRS associated with the SSB.

The PUSCH may comprise early CSI reporting contents, (e.g., on condition that Case 2 and/or ‘01’ or ‘11’ of the M-bit field) is indicated). The early CSI reporting contents may be determined based on measuring the indicated one or more CSI-RS resources (e.g., based on the QCL association with the SSB and/or the TRS if Case 1 is also indicated). The early CSI reporting contents may include at least one of a CSI-RS resource indicator (CRI), a rank indicator (RI), a precoding matrix indicator (PMI), and/or a value of CQI. The CSI reporting contents may be derived based on measuring the one or more CSI-RS resources.

The PUSCH may comprise early CSI reporting contents (e.g., by using a default mode, or if enabled by the network, with no indications of Case 1, Case 2), based on measuring the SSB (and/or PBCH DMRS associated with the SSB). The early CSI reporting contents may include a value of channel quality indicator (CQI) (e.g., from a defined or pre-configured CQI table, and/or derived based on measuring the 1-port SSB and/or the PBCH DMRS associated with the SSB.

Operations after transmitting the RACH Msg3 are considered here. The WTRU may receive a second DCI and a PDSCH (e.g., RRC setup message, a Msg4, etc.) scheduled by the second DCI. The PDSCH may (e.g., further) comprise at least one of following.

The PDSCH may comprise the second indication of one or more CSI-RS resources (e.g., if Case 2 was not indicated by the RAR). The second indication may refer to one or more CSI-RS resources from a plurality of CSI-RS resources that are configured during the previous RRC-connected state (e.g., where the WTRU got released by the same or a different serving-cell) from the previous RRC-connected state. The WTRU may have kept information such as the one or more CSI-RS resource configurations. The second indication may refer to one or more CSI-RS resources that were configured as a part of discontinuous reception (DRX) configuration.

The PDSCH may comprise an N-bit field (e.g., N=1), indicating whether or not the WTRU is to transmit an early CSI reporting along with a message for RRC reconfiguration-complete or setup-complete (e.g., Msg5) or a separate UL transmission. In examples, when N=1, the value of the field may correspond to the following: {‘0’: No early CSI reporting, ‘1’: Early CSI reporting after Msg3 or via a separate UL transmission}. In examples, when N=1:, the value of the field may correspond to the following: {‘0’: No early CSI reporting, ‘1’: Early CSI reporting in Msg5 or via a separate UL transmission}.

The WTRU may transmit a second PUSCH (e.g., Msg5) or an associated UL transmission (e.g., associated with a paging message being received), indicated by the PDSCH (e.g., Msg4) and/or by the RAR (e.g., if ‘11’ is the value of the M-bit field). The contents of the second PUSCH may comprise at least one of the following.

The second PUSCH may include early CSI reporting contents, based on measuring the indicated one or more CSI-RS resources (e.g., based on the QCL association with the SSB and/or the TRS if Case 1 is also indicated). The early CSI reporting contents may include at least one of CRI, RI, PMI, and/or CQI.

Examples of WTRU behavior on early CSI reporting based on aperiodic and/or periodic TRS are provided herein. In a solution, for the WTRUs accessing the base station with an SR (Service Request) (e.g., via sending Msg1, or a separate transmission for the SR), the base station may transmit (e.g., broadcast) information for early CSI (e.g., an Early-CSI-Feedback-Configuration (E-CSI-FC) IE). The information for early CSI may be included in system information blocks that WTRU can read when camping on the cell. The information for early CSI (e.g., E-CSI-FC) may include at least one of following.

The information for early CSI may include one or more TRS configurations without (e.g., QCL) association to any SSB. In such cases, an association may be made during the early CSI procedure. The information for early CSI may include one or more TRS (e.g., QCL'ed to the SSB) configurations that may have associated indexes. The information for early CSI may include a slot offset and/or a symbol offset related to the SSB reference for example. The information for early CSI may include CSI feedback information to be reported (e.g., one or any combination of wideband CQI, RI, etc.). The CSI feedback information may be included based on the early connection state and/or the time-window.

Upon PRACH transmission(s) (e.g., Msg1), the WTRU may receive a RAR message from the base station. The RAR message may contain an index pointing to a TRS linked to the configured information for early CSI (e.g., E-CSI-FC).

Upon reception of the RAR with the information for early CSI (e.g., E-CSI-FC) indicator, the WTRU may report in Msg3 early (e.g., basic) CSI feedback (e.g., at least including CQI). The WTRU may also report any necessary WTRU capabilities (e.g., maxRank, etc.,).

Upon reception of Msg3 with the above information, the base station may send a Msg4 that includes an extended CSI request and/or a scheduling grant.

Alternatively, or additionally, if the information for early CSI (e.g., E-CSI-FC) is not configured in the base station system information blocks, the RAR message may indicate the TRS to be used for the early CSI report and its report content. Upon reception of the RAR, the WTRU may perform the requested measurements and report them in Msg3 along with its capabilities (e.g., maxRank).

If the WTRU is not able to make and process the measurement before the scheduled Msg3 transmission, the WTRU may send an indication to the base station (e.g., in Msg3) that measurement was not yet performed, or that more time is needed to successfully transmit the determined early CSI, etc. The WTRU may indicate that the measurement was not successfully made prior to the transmission of Msg3 may be explicitly or implicitly. For example, it can be indicated implicitly via an out-of-range CQI value (for example CQI=0). In this case, the WTRU may wait for a message from the BS (e.g., Msg4 or other type of DL signal) for the next TRS configuration (e.g., and/or CSI-RS configurations). In examples, when the initial TRS was a “one shot” aperiodic configuration (e.g., that may be further associated with a periodic TRS), or if there is a periodic TRS, the WTRU may wait for the next reporting occasion along with a scheduled grant (e.g., PUSCH, carrying UCI) or PUCCH, etc.

A WTRU's early CSI reporting behavior while in an inactive/dormant state is discussed herein. In some solutions, the WTRU may measure and transmit information related to CSI measurement and/or reporting while the WTRU is in a state other than RRC connected and/or while the WTRU and/or network is within a dormant/inactive state. Such solutions may enable the WTRU to maintain updated CSI measurements so that they may be rapidly available when needed (e.g., upon resume of WTRU activity or transition to RRC Connected).

Early CSI reporting may be conducted via small data transmission. In some solutions the WTRU may continue to perform CSI measurement and reporting while outside of RRC connected state, for example, via small data transmission.

To support CSI measurement and reporting via small data transmission (SDT), WTRU may maintain one or more configuration(s) related to CSI measurement and reporting while outside of RRC Connected state (e.g., while the WTRU is in RRC INACTIVE or RRC IDLE state). Examples of such configurations may include, for example, measurement resources for CSI reporting (e.g., TRS(s), CSI-RS(s)). Whether the WTRU maintains the related configuration(s) may be explicitly indicated by the network, for example, within the RRC release with suspend indication (e.g., upon release to RRC INACTIVE), and/or via downlink small data transmission. In examples, the WTRU may receive a new set of CSI measurement/reporting configuration(s).

In examples, (e.g., even though a WTRU may maintain configuration(s) related to CSI measurement/reporting) whether the WTRU is allowed to perform CSI-related measurements and/or reporting may also be subject to network indication/approval. The network may disable both CSI measurements and/or reporting simultaneously (e.g., with a single bit/indication) or enable/disable one or more aspects individually. For example, the network may enable or disable a set of report quantities comprising at least one of CSI measurement value (e.g., CRI, RI, PMI, CQI, L1-RSRP, L1-SINR, etc.) and/or related measurement resources. In examples, the WTRU may receive a configuration to maintain one or more configuration(s) related to CSI measurement/reporting upon release from RRC connected state, along with an active state (e.g., CSI measurement is enabled, but CSI reporting is disabled etc.) In examples, the network may enable/disable CSI measurements/reporting dynamically (e.g., via system information, DCI, MAC CE, small data, or DL RACH signaling).

In examples, (e.g., if the WTRU has available configuration(s) and/or is enabled by the network) the WTRU may measure and/or report CSI-related information while in RRC INACTIVE state. The WTRU may continue measuring according to the maintained configuration and may report such measurements via small data transmission. In examples, the WTRU may perform such a transmission via dynamic grant. In examples, the WTRU may be provided with a configured grant (e.g., to report CSI-related information).

In examples, the WTRU may continue to measure and report CSI until otherwise indicated (e.g., until release to RRC IDLE, or an explicit indication to suspend CSI reporting). The WTRU may temporarily measure and report CSI. For example, upon release to RRC INACTIVE (e.g., upon reception of the RRC release with suspend indication) the WTRU may receive an indication of a time period (e.g., a duration) within the configuration wherein the WTRU can measure and report CSI. The duration may be maintained, for example, via a timer. The timer may start, for example, upon release to RRC INACTIVE. While the timer is running, the WTRU may perform CSI measurement and/or report CSI (e.g., via small data transmission). Upon timer expiry, the WTRU may suspend CSI measurement/reporting and/or release associated configurations. In another example, the WTRU may only measure a specific number of CSI measurement resources (e.g., L) and/or perform a specific number of CSI reports (e.g., K) while in RRC INACTIVE. Such solutions may be useful, for example, to avoid additional CSI reporting for a WTRU which is dormant for extended periods of time and may not need such up to date measurements.

In examples, the WTRU may continue (e.g., only continue) small data transmission of CSI reporting and/or measurements related to CSI subject to one or more conditions. For example, the WTRU may continue (e.g., only continue) such CSI related procedures if the WTRU remains connected to the same cell it was released from and/or if the cell is part of the same tracking area code (TAC), registration area (RNA), and/or public land mobile network (PLMN).

Early CSI reporting may be performed while in DRX. In another solution, the WTRU may perform CSI-related measurement(s) and/or reporting during dormant periods of WTRU activity (e.g., during DRX). In one example, the WTRU may temporarily ignore the dormancy period of DRX to perform one or more measurements related to CSI (e.g., the WTRU will ignore timers related to DRX inactivity). However, the WTRU may continue to ignore other DL reception and UL transmission during such periods. The WTRU may perform such additional measurements, for example, at a fixed periodicity, at a time period prior to the completion of the DRX dormant period and/or for a time period immediately after the beginning of the DRX dormant period. The WTRU may then store CSI related measurements and report them within the DRX Active period. The CSI related measurements may include measurements for at least one of the measurement values discussed herein (e.g., CRI, RI, PMI, CQI, L1-RSRP, L1-SINR, etc.). The measurements may include measurement values for CSI feedback (e.g., CRI, RI, PMI, CQI) and/or beam reporting (e.g., for beam management, based on CRI, L1-RSRP, L1-SINR, etc.). In one solution, the reporting of CSI related measurements will not affect DRX (e.g., will be independent of DRX). The WTRU may continue the DRX cycle (e.g., the WTRU will not start the DRX inactivity timer upon transmission of CSI report and will instead continue directly into DRX dormancy).

Whether the WTRU can perform additional measurements may be based on, for example, configuration of CSI measurement resources during the DRX cycle. In examples, the WTRU may request activation and/or configuration of additional CSI measurement resources within the DRX dormancy cycle. The WTRU may use these resources opportunistically. For example, based on one or more rules or conditions, the WTRU may perform measuring the additional CSI measurement resources, where the one or more rules or conditions are pre-defined or pre-configured (e.g., being associated with the cycle, based on time-domain index such as slot index which may have pre-association with a subset of the additional measurement resources, and so on). In examples, the WTRU may request the activation of additional measurement resources for an upcoming DRX dormancy cycle while in the preceding DRX active state. Such solutions will allow the WTRU to perform CSI related measurements prior to the return of DRX active time so that they will be readily available for subsequent transmission (e.g., if the WTRU has significant amounts of data upcoming). For example, the WTRU may perform CSI and/or beam related measurements during the dormant period of DRX, and perform reporting based on the measurements (e.g., as early as possible, by using a first available occasion for the reporting, based on a pre-defined or pre-configured rule/condition) during (e.g., or associated with) the active period.

In examples, the WTRU may perform similar measurement/reporting behavior while in DRX in RRC IDLE/INACTIVE period. Whether the WTRU can continue CSI related measurements may depend on, for example, the characteristics of the DRX configuration (e.g., the duration of the dormancy period, the duration of the active period) whether the WTRU is in RRC IDLE or RRC INACTIVE, and/or whether the WTRU is in DRXC or E-DRX.

Early CSI reporting may be performed while a cell is in a network energy saving state. In examples, the WTRU may perform CSI-related measurement(s) and/or reporting during periods of network energy saving. In one solution the WTRU may receive information related to the cell DTX/DRX cycle (e.g., via system information). The WTRU may perform CSI measurements aligned with the on duration of the cell DTX period and may perform CSI transmission during the on duration of the cell DRX period. In another example, the WTRU may request that the network continue to transmit one or more CSI-related RSs during the cell DTX period, and/or allow transmission of a CSI report during the cell DRX period.

In examples, the WTRU may continue to perform CSI-related measurements (e.g., while the WTRU is in a cell DTX period). However may not be able to transmit the CSI report (e.g., due to extended cell DRX periods). In examples, the CSI related measurements may include measurements for at least one of the measurement values discussed herein (e.g., CRI, RI, PMI, CQI, L1-RSRP, L1-SINR, etc.). The measurements may be for CSI feedback (e.g., CRI, RI, PMI, CQI) and/or beam reporting (e.g., for beam management, based on CRI, L1-RSRP, L1-SINR, etc.). In one solution, the WTRU may store CSI-related reports while the network is in cell DRX, and the WTRU may transmit one or more CSI reports when the cell re-enters cell DRX on duration. In another solution, the WTRU may continue to measure CSI-related measurements on a first cell and report the CSI-related measurements to a neighboring cell (e.g., indicating the PCI of the CSI measurements).

Early CSI reporting may be performed in association with a 2-step RACH procedure. Aspects of early CSI-RS measurement and CSI reporting when the WTRU initiates a 2-step RACH procedure are now considered. The WTRU may be configured with RACH occasions and PUSCH occasions for a 2-step RACH procedure. Each RACH occasion may be configured with an associated PUSCH occasion. Each PUSCH occasion may be configured with multiple PUSCH resources. Each PUSCH resource may include one or more RBs (e.g., a set of time and frequency locations).

The WTRU may transmit a first RACH message (e.g., msgA). The first RACH message may correspond to a joint transmission of a msg1 using a preamble selected from the RACH occasion, and a msg3 using a PUSCH resource from the associated PUSCH occasion. In the first RACH message (e.g., msgA), msg1 and msg3 may be sent on different time symbols (TDM). The WTRU may scramble its msg3 payload data as a function of the preamble index selected from the RACH occasion. The network may jointly receive the multiple msg3s on the same PUSCH resource and may detect and decode messages from one or more users by descrambling the PUSCH resource with the associated preamble indices. Multiple preambles may be associated to the same PUSCH resource so that multiple WTRUs may transmit on the same PUSCH resource.

After sending the first message, msgA, the WTRU then monitors for a second RACH message, msgB, response from the network on a PDCCH. The msgB may be scrambled with a msgB-RNTI. The msgB may correspond to the contention resolution messages in 4-step RACH procedures (e.g., msg2 and msg4).

In examples including early CSI reporting, the WTRU may send a msgA which includes a msg3 and/or a CSI report. The CSI report may be a separate payload from the msg3, or msg3 may include the CSI report within its payload. The WTRU may be configured with SSBs to measure downlink channel quality. Since SSBs are single-port resources, the WTRU may measure a coarse channel quality (e.g., SSB RSRP) based on (e.g., only on) SSBs. However, the WTRU may require a multi-port RS such as a CSI-RS to determine other reporting quantities such as CRI/RI/PMI/CQI.

In examples, the WTRU may select the type of RACH procedure (e.g., 4-step or 2-step RACH) to use for early CSI acquisition as a function of the CSI reporting quantities (e.g., or CSI payload size) that the WTRU determines to report. For example, if the WTRU determines to report (e.g., only) RSRP, the WTRU may select to initiate 2-step RACH. Whereas, if the WTRU determines to report PMI, the WTRU may select to initiate a 4-step RACH. Alternatively, or additionally, the WTRU may determine to perform early CSI reporting using 4-step RACH or 2-step RACH as a function of the RSRP being greater than a threshold.

In examples, SSBs or RACH occasions may be associated with a multi-port RS (e.g., CSI-RS) transmission for early CSI acquisition. The WTRU may acquire the CSI-RS configuration parameters from system information (e.g., a MIB and/or SIB). The WTRU may determine the RACH configuration. One or more CSI-RSs may be configured and associated with the RACH occasions and/or PUSCH occasions. The WTRU may determine reporting quantities (e.g., CRI/RI/PMI/CQI) from the early reporting CSI-RS which are transmitted within a time offset from the RACH occasion. For example, the WTRU may receive the RACH configuration for RACH occasion 1, and also a configuration for CSI-RS1 which includes an offset of S symbols from RACH occasion 1. If the WTRU selects a preamble from RACH occasion 1, the WTRU may monitor/measure the channel on the CSI-RS1 located on a symbol delayed by S symbols from RACH occasion 1. The associated PUSCH occasion for reporting CSI may be configured after S+delta symbols from the RACH occasion, where delta may correspond to the CSI computation delay. To avoid high latency, a subset of CSI reporting quantities may be defined for early CSI acquisition (e.g., only considering RSRP, CRI, RI reporting).

A WTRU may be configured with a subset of PUSCH occasions and/or PUSCH resources associated to each preamble index for reporting msg3, and another subset of PUSCH occasions and/or resources for reporting CSI. The WTRU may transmit the msg3 and/or the CSI jointly in msgA.

Additionally, or alternatively, a preamble may be associated to one PUSCH occasion which may be either for msg3 or for CSI report. The WTRU either transmit a msg3 (e.g., only a msg3), or a CSI report (e.g., only a CSI report) depending on which PUSCH occasion is linked to the preamble.

A RACH occasion may be associated with one or more PUSCH occasions. For example, if a RACH occasion is associated with two PUSCH occasions, the first PUSCH occasion may be configured to report msg3, and the second PUSCH occasion can be configured to report CSI. A preamble from the RACH occasion may be associated to one or more PUSCH occasions. The WTRU may determine the PUSCH occasions as a function of the preamble index. If the WTRU selects the preamble associated to two PUSCH occasions, the WTRU may transmit msg3 and a CSI on the respective PUSCH occasions.

In some cases, a preamble may be associated to one PUSCH occasion, and to multiple PUSCH resources within the PUSCH occasion. A first set of resources may be used for msg3, and the second set of resources can be used for CSI. The WTRU may determine the resource partition for msg3 and CSI as a function of the preamble index. If the WTRU selects the preamble, it may transmit the msg3 on the first set of resources and CSI on the second set of resources.

The number of PUSCH resources may be configured based on the CSI reporting payload size. In examples, one or more than one set of PUSCH resources may be configured to report different CSI reports including different CSI reporting quantities. The WTRU may select which CSI reporting quantities to report as a function of the preamble index.

For example, a WTRU may be configured with a first set of PUSCH resources for reporting CSIs with a first report quantity (e.g., ssb-Index-RSRP), and a second set of PUSCH resources for reporting CSIs with a second report quantity (e.g., cri-RI-i1). Each set of resources may be associated with a respective preamble index, P1 and P2. In such a case, if the WTRU initiates with P1, then the WTRU may report a CSI with ssb-Index-RSRP quantities on the first set of resources. If the WTRU initiates with P2, then the WTRU may report a CSI with cri-RI-i1 quantities on the second set of resources. Based on which preamble index is received, the network may determine the location of the PUSCH resource and the contents of the CSI report.

Additionally, or alternatively, a WTRU may be configured with a single set of PUSCH resources for reporting CSI, and the preamble indices may be associated to different CSI reporting quantities (e.g., through RRC). For example, two different preamble indices, P1 and P2, may be associated to the same set of PUSCH resources. If the WTRU selects preamble P1, the WTRU may scramble the CSI payload as a function of P1 to indicate that the payload corresponds to a first CSI reporting quantity. If the WTRU selects P2, the WTRU may scramble the CSI payload as a function of P2 to indicate that the payload corresponds to a second CSI reporting quantity.

If one preamble is associated to multiple PUSCH resources (e.g., one for msg3 and one for CSI report), and the msgB indicates that contention resolution failed (e.g., if the WTRU doesn't receive a PDCCH within the msgB response window, or if msgB includes a fallback RAR, or a backoff indicator), the WTRU may fallback to attempt a 2-step RACH procedure using (e.g., only using) preambles associated with a single PUSCH resource (e.g., or to one part of msgA). For example, the WTRU may select a first preamble associated to two PUSCH resources and send msg3 with a CSI report in msgA on their respective PUSCH resources. After msgB contention resolution failed, the WTRU may re-attempt a 2-step RACH procedure by selecting (e.g., only selecting) preambles associated with one PUSCH resource. On the re-attempt, the WTRU may (e.g., only) send msg3 or the CSI report.

Alternatively, or additionally, a new RAR may be included in msgB which indicates to the WTRU which part of the first msgA was successfully received from the initial attempt (e.g., msg3 or the CSI report). This may assist the WTRU when re-attempting the RACH procedure to send a msgA for the part that was not successfully received.

The WTRU may monitor a single msgB-RNTI associated with msgA. Alternatively, or additionally, two or more different msgB-RNTIs may be configured, where a first msgB-RNTI is sent in response to a msg3 request, and a second msgB-RNTI is sent in response to a CSI report. If the WTRU sends both msg3 and CSI report in msgA, the WTRU may monitor both msgB responses. Separate msgB responses may be used by the network if the WTRU uses two or more PUSCH resources for msgA to report msg3 and the CSI report, and if the two or more PUSCH resources are separated in time by more than a threshold (e.g., the WTRU requires more time to measure/calculate the CSI report than sending msg3). The two or more msgB-RNTIs may be indexed by the preamble index, and additionally the PUSCH resource occasion/resource index. The WTRU may start monitoring for the msgBs after sending msgA.

Alternatively, or additionally, the WTRU may fall back to 4-step RACH if msg3 or the CSI report is not successfully received. The WTRU may fall back to any of the solutions discussed herein for early CSI reporting using 4-step RACH.

A WTRU may receive a backoff indicator in the MAC PDU of the MAC-CE for msgB. The backoff indicator may include a time delay, T_backoff, which starts from the time of msgB reception. The WTRU may set the PREAMBLE_BACKOFF timer to T_backoff and initiate a RACH procedure again when the timer expires. In some examples, if the WTRU initiated a 2-step RACH procedure with the transmission of msgA, including msg3 and CSI report, the WTRU may receive a msgB with a backoff indicator which includes one or more than one T_backoff. Each T_backoff may indicate a delay the WTRU shall wait before attempting to initiate a RACH procedure for msg3 and/or the CSI report, respectively. For example, the WTRU may initiate a 2-step RACH procedure with msgA including msg3 and CSI report. The WTRU may then receive a msgB response with T_backoff1 and T_backoff2. The WTRU may set the PREAMBLE_BACKOFF timer to T_backoff1, and initiates a RACH procedure with msgA including msg3, but not the CSI report after T_backoff1 seconds. After sending msgA, the WTRU may set the PREAMBLE_BACKOFF timer to T_backoff2 and initiate a RACH procedure with msgA containing the CSI report after T_backoff2 seconds.

1. A wireless transmit/receive unit (WTRU) comprising
a processor configured to:
receive system information (SI) comprising a synchronization signal block (SSB);
transmit a first physical random access channel (PRACH) message based on the SSB;
receive a random access response (RAR), wherein the RAR comprises one or more parameters for early channel state information (CSI) reporting, wherein the parameters for early CSI reporting indicate a resource for early CSI measurement, wherein early CSI measurement and early CSI reporting are to be performed in association with a random access procedure;
determine a quasi-co-location (QCL) association between the resource for early CSI measurement and the SSB;
determine a CSI measurement of the resource for early CSI measurement, based on the determined QCL association; and
send an early CSI report indicating the CSI measurement.

2. The WTRU of claim 1, wherein the RAR further comprises a field that indicates that the WTRU should perform early CSI reporting.

3. The WTRU of claim 2, wherein the RAR comprises a field that indicates a time or event, after which the WTRU is to perform early CSI reporting.

4. The WTRU of claim 1, wherein the resource for early CSI measurement comprises a tracking reference signal (TRS), and wherein the processor is configured to determine the measurement of the resource for early CSI measurement by measuring the TRS.

5. The WTRU of claim 1, wherein the resource for early CSI measurement comprises a demodulation reference signal (DMRS) associated with the SSB, and wherein the processor is configured to determine the measurement of the resource for early CSI measurement by measuring the SSB and the DMRS.

6. The WTRU of claim 1, wherein the processor is configured to:
determine a CSI measurement of the resource for early CSI measurement by performing a layer 1 (L1) reference signal received power (RSRP) measurement or a L1 signal to interference plus noise ratio (SINR).

7. The WTRU of claim 1, wherein the processor is configured to send the early CSI report in a message that is associated with a random access procedure.

8. The WTRU of claim 7, wherein the message that is associated with a random access procedure is a random access message 3 (Msg3).

9. The WTRU of claim 1, wherein the early CSI measurement indicates a rank indicator (RI), a precoding matrix indicator (PMI), or a channel quality indicator (CQI).

10. The WTRU of claim 1, wherein the QCL association indicates a doppler shift, a delay, or a spatial relationship between the resource for early CSI measurement and the SSB.

11. A method for use by a wireless transmit/receive unit (WTRU), the method comprising
receiving system information (SI) comprising a synchronization signal block (SSB);
transmitting a first physical random access channel (PRACH) message based on the SSB;
receiving a random access response (RAR), wherein the RAR comprises one or more parameters for early channel state information (CSI) reporting, wherein the parameters for early CSI reporting indicate a resource for early CSI measurement, wherein early CSI measurement and early CSI reporting are to be performed in association with a random access procedure;
determining a quasi-co-location (QCL) association between the resource for early CSI measurement and the SSB;
determining a CSI measurement of the resource for early CSI measurement, based on the determined QCL association; and
sending an early CSI report indicating the CSI measurement.

12. The method of claim 11, wherein the RAR further comprises a field that indicates that the WTRU should perform early CSI reporting.

13. The method of claim 12, wherein the RAR comprises a field that indicates a time or event, after which the WTRU is to perform early CSI reporting.

14. The method of claim 11, wherein the resource for early CSI measurement comprises a tracking reference signal (TRS), the method further comprising: determining a measurement of the resource for early CSI measurement by measuring the TRS.

15. The WTRU of claim 11, wherein the resource for early CSI measurement comprises a demodulation reference signal (DMRS) associated with the SSB, the method further comprising: determining the measurement of the resource for early CSI measurement by measuring the SSB and the DMRS.

16. The method of claim 11, further comprising:
determining a CSI measurement of the resource for early CSI measurement, by performing a layer 1 (L1) reference signal received power (RSRP) measurement or a L1 signal to interference plus noise ratio (SINR).

17. The method of claim 11, further comprising sending the early CSI report in a message that is associated with a random access procedure.

18. The method of claim 17, wherein the message that is associated with a random access procedure is a random access message 3 (Msg3).

19. The method of claim 11, wherein the early CSI measurement indicates a rank indicator (RI), a precoding matrix indicator (PMI), or a channel quality indicator (CQI).

20. The method of claim 11, wherein the QCL association indicates a doppler shift, a delay, or a spatial relationship between the resource for early CSI measurement and the SSB.
